(19) United States
(12) Patent Application Publication
(10) Pub. No.: US 2012/0273133 A1
(43) Pub. Date: Nov. 1, 2012

(54) SURFACE PROTECTIVE FILM, GAS CONTACT MEMBER, GAS PROCESSING APPARATUS, AND MECHANICAL PUMP

(76) Inventors: Tadahiro Ohmi, Sendai-shi (JP); Toshiya Umeki, Sendai-shi (JP); Isao Akutsu, Sendai-shi (JP)

(21) Appl. No.: 13/511,677

(22) PCT Filed: Nov. 9, 2010
(86) PCT No.: PCT/JP2010/069886

§ 371 Date: May 24, 2012

(30) Foreign Application Priority Data
Nov. 26, 2009 (JP) 2009-269201

(51) Int. Cl. C09D 1/00; F04B 53/00; B05C 11/00

(52) U.S. Cl. 156/345.29; 106/286.1; 417/437

(57) ABSTRACT

An object of this invention is to provide a surface protective film which is capable of suppressing the entry of a corrosive gas as compared with conventional surface protective films. A surface protective film according to this invention is a film which contains yttria (Y₂O₃) as a main component and also contains cerium. Since the surface protective film contains cerium, defects such as micropores in the film are reduced, thereby enabling suppression of the entry of a corrosive gas.

### TECHNICAL FIELD

This invention relates to a surface protective film, a gas contact member, a gas processing apparatus, and a mechanical pump.

### BACKGROUND ART

In a gas processing apparatus, for example, in an exhaust apparatus such as a mechanical pump or in an apparatus using a gas in a process treatment, a surface of a member of a gas contact portion which is brought into contact with a gas to be discharged should be coated with a protective film.

This is because, in an apparatus that discharges a toxic gas, a corrosive gas, or the like at a reduced pressure, or in a vacuum pump or the like used in an exhaust portion of the apparatus, there is a possibility that the gas is reacted in the apparatus, the pump, or the like, thereby corroding a gas contact portion.

As such an apparatus, there is cited, for example, an apparatus that is used in a process (plasma etching, low-pressure vapor deposition) in a semiconductor manufacturing apparatus, a large thin display manufacturing apparatus, or a solar cell manufacturing apparatus.

This is also because there is a problem that if the gas contact portion is not coated with the protective film, the gas is decomposed or dissociated due to the catalytic action of a material forming the surface of the gas contact portion, so that a reaction product is deposited to impede the normal operation of the apparatus, the pump, or the like.

More specifically, while there is a case where a gas contact portion of a conventional mechanical pump, for example, is treated with nickel, nickel has a catalytic effect on molecules of a hydrogen compound such as SiH₄, AsH₃, PH₃, or B₂H₆ which is a gas for use in a process (plasma etching, low-pressure vapor deposition) in a semiconductor manufacturing apparatus, a large thin display manufacturing apparatus, or a solar cell manufacturing apparatus.

Accordingly, there is a problem that the molecules of the hydrogen compound such as SiH₄, AsH₃, PH₃, or B₂H₆, which is frequently used in the semiconductor process, are decomposed due to the catalytic effect of nickel of the gas contact portion in the pump, so that Si, As, P, or B is produced and is, by a chemical reaction, deposited as a product in the mechanical pump.

In view of this, there is proposed a structure in which a surface of a gas contact portion is coated with an yttria (yttrium oxide, Y₂O₃) film excellent in corrosion resistance and having no catalytic effect, thereby suppressing decomposition or dissociation of a gas and thus suppressing deposition of a product in a pump (Patent Document 1).

### PRIOR ART DOCUMENT

### Patent Document

Patent Document 1: JP-A-2008-88912

### SUMMARY OF THE INVENTION

### Problem to be Solved by the Invention

The technique described in Patent Document 1 is excellent in terms of being capable of obtaining the effect of suppressing decomposition or dissociation of a gas and suppressing deposition of a product in the pump.

However, the yttria (Y₂O₃) film possibly has defects such as fine pores in the film. If there are such defects, it may be difficult to prevent entry of a corrosive gas to the surface of the gas contact portion. Therefore, it is more preferable if this can be improved.

This invention has been made in view of the above-mentioned problem and it is an object of this invention to provide a surface protective film that can suppress entry of a corrosive gas more than conventional.

It is another object of this invention to provide a gas contact member having high resistance to a corrosive gas and to provide a gas processing apparatus and a mechanical pump each using such a member.

### Means for Solving the Problem

According to a first aspect of this invention, there is provided a surface protective film characterized by being composed mainly of yttria (Y₂O₃) and containing cerium.

In the above-mentioned surface protective film, the addition amount of cerium is preferably set to 1 to 5% in atomic composition ratio in terms of oxide.

According to a second aspect of this invention, there is provided a gas contact member characterized by having the surface protective film according to the first aspect at least in a gas contact portion.

According to a third aspect of this invention, there is provided a gas processing apparatus characterized by using the gas contact member according to the second aspect.

According to a fourth aspect of this invention, there is provided a mechanical pump characterized by having, on a surface of a gas contact portion which is a portion to be brought into contact with a gas to be discharged, a surface protective film which is an yttria film added with cerium oxide.

Also in the above-mentioned mechanical pump, the addition amount of cerium in the surface protective film is preferably set to 1 to 5% in atomic composition ratio in terms of oxide.

According to a fifth aspect of this invention, there is provided a semiconductor manufacturing apparatus characterized by comprising the mechanical pump according to the fourth aspect, a process chamber from which a gas is discharged by the mechanical pump, and a pipe disposed between the process chamber and the mechanical pump, wherein the surface protective film is provided on an inner surface of at least one of the process chamber and the pipe.

According to a sixth aspect of this invention, there is provided a thin display manufacturing apparatus characterized by comprising the mechanical pump according to the fourth aspect, a process chamber from which a gas is discharged by the mechanical pump, and a pipe disposed between the process chamber and the mechanical pump, wherein the surface protective film is provided on an inner surface of at least one of the process chamber and the pipe.

According to a seventh aspect of this invention, there is provided a solar cell manufacturing apparatus characterized by comprising the mechanical pump according to the fourth aspect, a process chamber from which a gas is discharged by the mechanical pump, and a pipe disposed between the process chamber and the mechanical pump, wherein the surface protective film is provided on an inner surface of at least one of the process chamber and the pipe.

According to an eighth aspect of this invention, there is provided a mechanical pump manufacturing method for manufacturing the mechanical pump according to the fourth aspect, characterized by forming the surface protective film by a sol-gel method.

### Effect of the Invention

According to this invention, it is possible to provide a surface protective film that can suppress entry of a corrosive gas more than conventional.

Further, according to this invention, it is possible to provide a gas contact member having high resistance to a corrosive gas and to provide a gas processing apparatus and a mechanical pump each using such a member.

### BRIEF DESCRIPTION OF THE DRAWINGS

FIG. 1 is a cross-sectional view showing one example of a screw pump (mechanical pump) according to an embodiment of this invention.

### MODE FOR CARRYING OUT THE INVENTION

Hereinbelow, an embodiment of this invention will be described in detail with reference to the drawings.

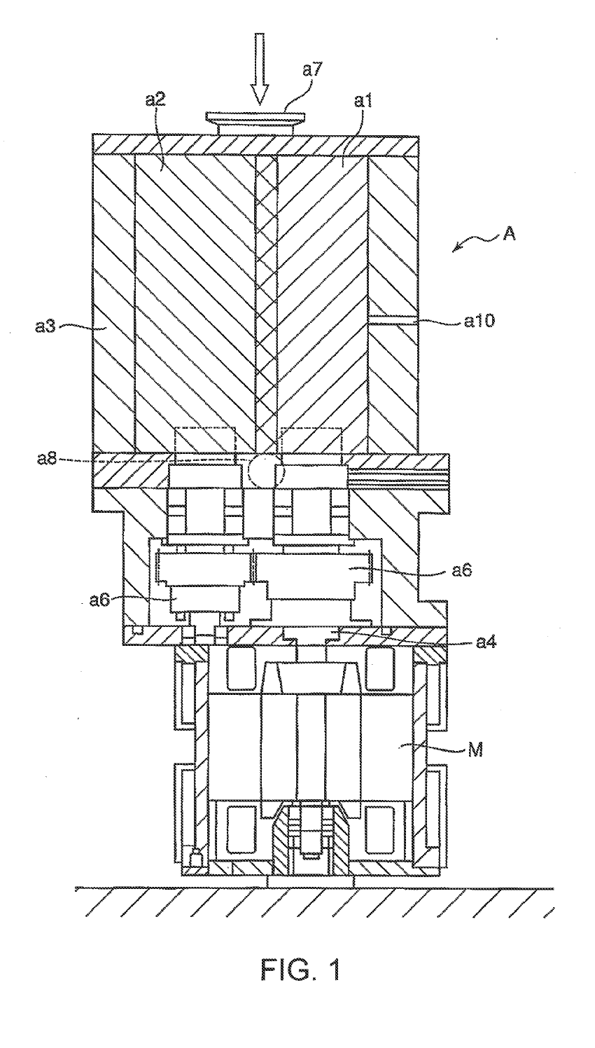

First, referring to FIG. 1, the structure of a screw pump (mechanical pump) as a gas processing apparatus having a surface protective film according to this embodiment and the structure of the surface protective film will be described.

As shown in FIG. 1, the screw pump comprises a screw pump body A, a motor M, and a temperature control means (not illustrated) for maintaining gas contact portions (described later) of the screw pump body A at a predetermined temperature.

The screw pump body A has a pair of screw rotors a1 (a2) each having a plurality of helical lands and grooves and respectively adapted to rotate about substantially parallel two axes while meshing with each other.

The screw rotors a1 (a2) are received in a casing a3 and are rotatably supported by only one bearing of a shaft a4 supporting the screw rotors al (a2).

Timing gears a6 are attached to one end of the shaft a4. The pair of screw rotors al (a2) are configured to rotate synchronously with each other through the timing gears a6. The motor M is attached to the other end of the shaft a4.

On the other hand, an inlet port a7 is formed at an upper end of the casing a3 receiving therein the screw rotors al (a2), while an outlet port a8 is formed on the lower end side of the casing a3. It is configured such that when the screw rotors al (a2) are synchronously rotated by the rotation of the motor M, a gas is introduced through the inlet port a7 and discharged from the outlet port a8, i.e. the action of a vacuum pump is achieved.

Further, the casing a3 is formed with an inert gas injection hole a10 at its portion approximately in the middle in the rotation axis direction of the screw rotors al (a2). A gas injected through the inert gas injection hole a10 enters the pair of screw rotors al (a2) and dilutes the gas in gaps between both rotors, thereby improving the discharge of a low molecular weight gas and suppressing the generation of a product and corrosion.

Herein, a surface protective film is coated on surfaces of members (gas contact portions), which are brought into contact with the exhaust gas, of the screw rotors al (a2), the casing a3, the inlet port a7, the outlet port a8, and so on.

The surface protective film is a film which is composed mainly of yttria (Y₂O₃) and contains cerium.

More specifically, it is preferable that the surface protective film be the film containing cerium oxide (CeO₂) and that the cerium content be 1% to 5% in atomic ratio in terms of oxide.

By adding the cerium oxide to the yttria (Y₂O₃) in the above-mentioned range, it is possible to reduce defects such as fine pores in the yttria film and thus to suppress entry of the corrosive gas as compared with a conventional yttria (Y₂O₃) film.

The coating thickness of the surface protective film is preferably set to 0.1 to 10 μm. This is because if the coating thickness is not more than 0.1 μm, there is a possibility of the presence of points where the underlying surface is exposed through penetrating pores, while if the coating thickness is not less than 10 μm, there is a possibility of the occurrence of film separation due to the film stress.

As a surface protective film coating method, there is cited, for example, a method in which yttria (Y₂O₃) containing cerium oxide is sol-gel coated on a surface of a component member (in this embodiment, a member forming a gas contact portion) and then a heat treatment is carried out at 250° C. to 1000° C. in an atmosphere of nitrogen and oxygen in the ratio of 80:20. However, it is not necessarily limited to the above-mentioned method.

The surface protective film thus obtained is a film with excellent corrosion resistance, with no catalytic effect, and with less surface defects than conventional and, therefore, using it as a surface protective film for the members of the gas contact portions of the pump, it serves to suppress decomposition or dissociation of the exhaust gas and thus to suppress deposition of a product in the pump.

By applying the surface protective film of this invention to the members of the gas contact portions as described above, it is possible to improve the reliability of the gas processing apparatus such as the pump.

Accordingly, it is possible to suppress the deposition of the reaction product and thus to ensure the normal operation of the pump for a long period of time.

In order to further suppress the deposition of the product in the screw pump, the temperature of (the gas contact portions of) the screw pump body A is preferably maintained at 80° C. or more. On the other hand, in order to keep the performance of the screw pump, the temperature of the screw pump body A is preferably maintained at 250° C. or less.

Accordingly, it is preferable to maintain the temperature of (the gas contact portions of) the screw pump body A in the range of 80° C. to 250° C. and it is more preferable to maintain the temperature of the screw pump body A at about 150° C.

In order to maintain the temperature of the gas contact portions in the range of 80 to 250° C., the screw pump has the temperature control means as described above.

For example, although not illustrated, this temperature control means has an electric heater and a cooling structure. The cooling structure is such that the casing a3 is formed with a cavity and that a coolant such as cooling water or oil is circulated through the cavity. The electric heater and the cooling structure perform feedback control of the temperature of the gas contact portions based on a temperature monitored by a temperature sensor provided at a predetermined position of the screw pump body A.

Instead of the electric heater, the gas compression heat generated by the operation of the screw pump, the frictional heat of the operating members, or the like may be used as a heat source.

The screw pump according to this embodiment is, for example, used for exhausting a gas to be discharged from a process chamber of a semiconductor manufacturing apparatus, a thin display manufacturing apparatus such as a liquid crystal display manufacturing apparatus, a solar cell manufacturing apparatus, or the like. It is preferable that the surface protective film according to this embodiment be also formed on an inner surface of the process chamber of the apparatus and on an inner surface of a pipe disposed between the process chamber and the screw pump.

As described above, according to this embodiment, the protective film composed mainly of yttria (Y₂O₃) and containing cerium is coated on the gas contact portions of the screw pump.

Therefore, it is possible to suppress the entry of the corrosive gas more than conventional.

### EXAMPLE

Hereinbelow, this invention will be described in further detail with reference to an Example.

Samples respectively having, on substrates, surface protective films containing cerium in various ratios were prepared using a sol-gel method. Then, the entering amount of a corrosive gas into each surface protective film was measured.

Specifically, a test was conducted in the following manner.

[Preparation of Samples]

First, as MOD (Metal Organic Decomposition) coating-type Y-Ce coating solutions, mixtures of MOD coating-type Y-03 and Ce-03 manufactured by Kojundo Chemical Lab. Co., Ltd. in which CeO₂ was contained in predetermined ratios of 1 to 5% in atomic ratio in terms of oxide were respectively coated on Si substrates, each having a diameter of 33 mm, using a spin coater at a rotational speed of 1500 rpm for 60 seconds. After the coating, samples were heated using an IR furnace (far-infrared heating furnace).

Specifically, the heating was carried out in the following manner.

First, in order to remove organic components in the coating materials, the samples were heated in the state where the IR furnace was heated to 400° C. at a heating rate of 5° C./min and a N₂ gas was caused to flow at 1 L/min at a reduced pressure of STorr (6.7×10² Pa), wherein the IR furnace was maintained at 400° C. for 8 hours.

Then, after returning the pressure to the atmospheric pressure, oxidation was carried out for 1 hour in a 100% 0₂ atmosphere.

After the oxidation, natural cooling to room temperature was carried out.

In the manner described above, the samples formed with surface protective films on the substrates were prepared.

[Exposure of Samples to Corrosive Gas]

Then, the samples were exposed to a highly corrosive 100% Cl₂ gas in the following manner.

First, the samples were set in a SUS pipe whose inner surface was treated with Al₂O₃. Then, while causing N₂ to flow at 1000 L/min, the pipe was heated to 150° C. at 5° C./min and then was maintained at 150° C. for 1 hour, thereby removing water adsorbed to the sample surfaces.

Then, the N₂ gas was changed to a Cl₂ gas and exposure was carried out at a pressure of 3 kgf/cm² (2.9×10⁴ Pa) for 24 hours.

[Evaluation of Samples]

Then, with respect to the samples exposed to the Cl₂ gas, the Cl detection depth (entering amount) was measured by JPS-9010-MX being a photoelectron spectrometer (XPS, X-ray Photoelectron Spectroscopy) manufactured by JEOL Ltd. (JEOL).

Specifically, the measurement was carried out at three arbitrary positions in the plane in the 1 mm diameter range and the average value was calculated.

The results are shown in Table 1.

TABLE 1

| | CeO₂ Addition | Baking | Degassing | Cl Entering |
|---|---|---|---|---|
| | Amount | Temperature | Time | Amount |
| Number | [at %] | [° C.] | [Hour] | [nm] |
| 1 | 0 | 400 | 8 | 10 |
| 2 | 1 | 400 | 8 | 6 |
| 3 | 2 | 400 | 8 | 7 |
| 4 | 2.5 | 400 | 8 | 5 |
| 5 | 3 | 400 | 8 | 6 |
| 6 | 4 | 400 | 8 | 5 |
| 7 | 5 | 400 | 8 | 5 |

As is clear from Table 1, the Cl gas entering amount was smaller in each of the films of test numbers 2 to 7 added with CeO₂ than that in a film of test number 1 (Y₂O₃ simple substance film).

This is considered to be because defects such as fine pores in the film were reduced by the addition of CeO₂.

From the above, it is seen that the entry of the corrosive gas can be suppressed by adding CeO₂ to yttria (Y₂O₃).

### INDUSTRIAL APPLICABILITY

In the above-mentioned embodiment, the description has been given of the case where this invention is applied to the screw pump. However, this invention is not particularly limited thereto and is of course also applicable to mechanical pumps in general such as a Roots pump, other gas processing apparatuses, gas pipelines, and so on. Since a gas processing apparatus applied with this invention maintains the stable performance for a long period of time, the stable system operation can be achieved.

A mechanical pump according to this invention is applicable to the whole range of apparatuses that require gas exhaustion, such as a semiconductor manufacturing apparatus, a thin display manufacturing apparatus, and a solar cell manufacturing apparatus.

Further, a mechanical pump according to this invention is applicable not only to the case where an object to be discharged is a gas, but also to a structure which discharges a medium in general such as a liquid.

In the above-mentioned Example, the Si substrate was used as a substrate. However, even if a SUS-based material or an Al-based material is used as a substrate, the same effect can be obtained.

In the above-mentioned Example, the coating was carried out by the spin coater. However, even if the coating is carried out by a dipping method or a spray method, the same effect can be obtained.

In the above-mentioned Example, the samples were heated using the

IR furnace. However, even if actual heating is carried out using an external heater (oven), the same effect can be obtained.

### Description of Symbols

A screw pump body

a1, a2 screw rotors

a3 casing

a4 shaft

a6 timing gear

a7 inlet port

a8 outlet port

a10 inert gas injection hole

M motor

1. A surface protective film being composed mainly of yttria (Y₂O₃) and containing cerium.

2. The surface protective film according to claim 1, wherein a content of the cerium is set to 1% to 5% in atomic ratio in terms of oxide.

3. A gas contact member having the surface protective film according to claim 1 at least in a gas contact portion.

4. A gas processing apparatus using the gas contact member according to claim 3.

5. A mechanical pump having, on a surface of a gas contact portion which is a portion to be brought into contact with a gas to be discharged, a surface protective film which is a yttria film added with cerium oxide.

6. The mechanical pump according to claim 5, wherein a cerium addition amount in the surface protective film is 1 to 5% in atomic ratio in terms of oxide.

7. The mechanical pump according to claim 5, comprising a body formed with a gas inlet port and a gas outlet port in a casing receiving therein a rotor,
wherein, in the body, the surface protective film is coated to a thickness of 0.1 to 10 μm on the surface of the gas contact portion being the portion to be brought into contact with the gas.

8. The mechanical pump according to claim 7, comprising temperature control means for maintaining a temperature of the body in a range of 80° C. to 250° C.

9. The mechanical pump according to claim 8, wherein the temperature control means includes heating means.

10. The mechanical pump according to claim 9, wherein the temperature control means uses at least one of gas compression heat generated by operation of the mechanical pump and frictional heat of an operating member.

11. A semiconductor manufacturing apparatus comprising the mechanical pump according to claim 5, a process chamber from which a gas is discharged by the mechanical pump, and a pipe disposed between the process chamber and the mechanical pump, wherein the surface protective film is provided on an inner surface of at least one of the process chamber and the pipe.

12. A thin display manufacturing apparatus comprising the mechanical pump according to claim 5, a process chamber from which a gas is discharged by the mechanical pump, and a pipe disposed between the process chamber and the mechanical pump, wherein the surface protective film is provided on an inner surface of at least one of the process chamber and the pipe.

13. A solar cell manufacturing apparatus comprising the mechanical pump according to claim 5, a process chamber from which a gas is discharged by the mechanical pump, and a pipe disposed between the process chamber and the mechanical pump, wherein the surface protective film is provided on an inner surface of at least one of the process chamber and the pipe.

14. A mechanical pump manufacturing method for manufacturing the mechanical pump according to claim 5, comprising forming the surface protective film by a sol-gel method.

15. The mechanical pump manufacturing method according to claim 14, comprising forming the surface protective film by the sol-gel method including a heat treatment in a range of 250 to 1000° C.
